(19) United States
(12) Patent Application Publication
(10) Pub. No.: US 2024/0202709 A1
(43) Pub. Date: Jun. 20, 2024

(54) CARD OWNERSHIP MANAGEMENT SYSTEM, CARD OWNERSHIP MANAGEMENT METHOD, AND PROGRAM

(71) Applicant: PLAYTHINK, INC., Tokyo (JP)

(72) Inventors: Taro UGAWA, Tokyo (JP); Yoshifumi OHASHI, Tokyo (JP)

(73) Assignee: PLAYTHINK, INC., Tokyo (JP)

(21) Appl. No.: 18/287,798

(22) PCT Filed: Feb. 16, 2022
(86) PCT No.: PCT/JP2022/006108

§ 371 Date: Oct. 20, 2023

(30) Foreign Application Priority Data
Apr. 22, 2021 (JP) 2021-072882

(51) Int. Cl. G06Q 20/36

(52) U.S. Cl. CPC G06Q 20/3678

(57) ABSTRACT

An exchange instruction is received from a user terminal, the exchange instruction including information specifying a card token for exchange held in an operator wallet that holds a plurality of card tokens and information specifying one or more card tokens held in a user wallet that holds one or more card tokens owned by a user of the user terminal; moves the card token for exchange specified based on the exchange instruction to the user wallet from the operator wallet; and moves one or more card tokens specified based on the exchange instruction to the operator wallet from the user wallet.

### FIELD OF THE INVENTION

The present invention relates to a card ownership management system, a card ownership management method, and a program, and in particular to a card ownership management system, a card ownership management method, and a program for managing a trading card ownership.

### BACKGROUND OF THE INVENTION

Trading cards are ornamental cards that are for sale or distributed for the purpose of collecting these cards. In Japan, trading cards distributed packaged together with snack “J-League chips” and trading cards printed with image of animation “Pocket Monsters” are well known.

Since trading cards alone are considered valuable, there are vendors who buy the trading cards from users and resell the cards. Patent Literature 1 discloses a system that reduces time required for a trading card purchase assessment and costs such as labor.

In addition, there are social games that utilize trading cards by converting to digital cards in recent years. Patent Literature 2 discloses an example of such a game.

### RELATED ART

### Patent Literature

Patent Literature 1: Japanese Patent Laid-open Publication No. 2019-082870
Patent Literature 2: Japanese Patent Laid-open Publication No. 2021-037199

### SUMMARY OF THE INVENTION

### Problems to be Solved by the Invention

Once a trading card is sold by a person who first puts for sale or distributes the trading card (hereafter referred to as an “operator”), the card becomes independent and will be freely circulated in the market. The only thing the operator could do to control the number of trading cards circulating in the market was to adjust the number of newly issued cards.

In contrast, when a trading card is prepared that can only be obtained through exchanging with another trading card (hereafter referred to as a “card for exchange”), it is considered that the operator can freely control the number of trading cards circulating in the market, including reducing the number of trading cards circulating in the market by setting an appropriate exchange content.

However, in conventional trading cards, issuance of cards for exchange described above was not possible. In other words, in order to exchange trading cards, a trading card must be mailed and thus it incurs a mailing cost. Possible methods to collect the mailing cost include charging a fee for exchanging a trading card or reselling the trading card that is obtained, but the former is difficult from a business perspective, and the latter relies on the condition of the trading card that is obtained. As a result, the cards for exchange were not utilized in the past.

In contrast, when the trading cards are converted to digital cards, the cards can be exchanged without incurring a mailing cost, and reselling is also possible without relying on the condition of the trading cards. However, as described in Patent Literature 2, conventional digitalized trading card (hereafter referred to as a “digital trading card”) only grants the user a right to use the card for a limited term, and the user does not have ownership. Therefore, the above issues on the conventional trading card regarding user ownership were not solved.

Accordingly, one of the purposes of the present invention is to provide a card ownership management system, a card ownership management method, and a program that can issue cards for exchange.

### Means for Solving the Problems

The card ownership management system according to the present invention is a card ownership management system that receives from a first user terminal an exchange instruction including information specifying a non-fungible token for exchange held in an operator wallet that holds a plurality of non-fungible tokens and information specifying one or more non-fungible tokens held in a first user wallet that holds one or more non-fungible tokens owned by a user of the first user terminal; moves the non-fungible token for exchange specified based on the exchange instruction to the first user wallet from the operator wallet; and moves one or more non-fungible tokens specified based on the exchange instruction to the operator wallet from the first user wallet.

The card ownership management method according to the present invention is a card ownership management method executed by a computer, and includes a step of receiving, by the computer, from the first user terminal the exchange instruction including information specifying the non-fungible token for exchange held in the operator wallet that holds the plurality of non-fungible tokens and information specifying one or more non-fungible tokens held in the first user wallet that holds one or more non-fungible tokens owned by the user of the first user terminal; a step of moving, by the computer, the non-fungible token for exchange specified based on the exchange instruction to the first user wallet from the operator wallet; and a step of moving one or more non-fungible tokens specified based on the exchange instruction to the operator wallet from the first user wallet.

The program according to the present invention is a program in which a computer executes a step of receiving from the first user terminal the exchange instruction including information specifying the non-fungible token for exchange held in the operator wallet that holds the plurality of non-fungible tokens and information specifying one or more non-fungible tokens held in the first user wallet that holds one or more non-fungible tokens owned by the user of the first user terminal; a step of moving the non-fungible token for exchange specified based on the exchange instruction to the first user wallet from the operator wallet; and a step of moving one or more non-fungible tokens specified based on the exchange instruction to the operator wallet from the first user wallet.

### Effect of the Invention

According to the present invention, a non-fungible token which can give a user ownership is used as a trading card, and the non-fungible token is also used for exchange, and therefore, the trading card can be exchanged without sending in the mail. In addition, since the non-fungible token (trading card) does not deteriorate, the non-fungible token for exchange or the non-fungible token for sale that is obtained through exchange can also be resold or redistributed. Therefore, issuing the trading card for exchange becomes possible.

### BRIEF DESCRIPTION OF THE DRAWINGS

FIG. 1 illustrates a configuration of a card ownership management system 1 according to the present embodiment.

FIG. 2 illustrates an exemplary hardware configuration of an operating terminal 3, user terminal 4, NFT management server 5, and application server 6.

FIG. 3 is a schematic block diagram illustrating a functional block of the NFT management server 5 and the application server 6.

FIG. 4 illustrates examples of screens displayed on the user terminal 4 that is a smartphone (a first interface for a user to purchase a card token for sale).

FIG. 5 illustrates examples of screens displayed on the user terminal 4 that is the smartphone (a second interface to exchange a card token for exchange with a card token held in a user wallet UW).

FIG. 6 illustrates examples of screens displayed on the user terminal 4 that is the smartphone (a third interface for trading the card token held in the user wallet UW between users).

FIG. 7 illustrates examples of screens displayed on the user terminal 4 that is the smartphone (the third interface for trading the card token held in the user wallet UW between the users).

FIG. 8 is a sequence diagram illustrating a process of issuing a new card token.

FIG. 9 is a diagram describing a general flow of purchasing and exchanging card tokens.

FIG. 10 is a sequence diagram illustrating a process of purchasing a card token.

FIG. 11 is a sequence diagram illustrating a process of exchanging the card token.

FIG. 12 is a sequence diagram illustrating a trading of the card token between the users.

FIG. 13 is a sequence diagram illustrating a process of reprinting the card token.

FIG. 14 is a sequence diagram illustrating a process of reprinting the card token.

### MODE FOR CARRYING OUT THE INVENTION

Hereafter, an embodiment of the present invention is described in detail with reference to the attached drawing.

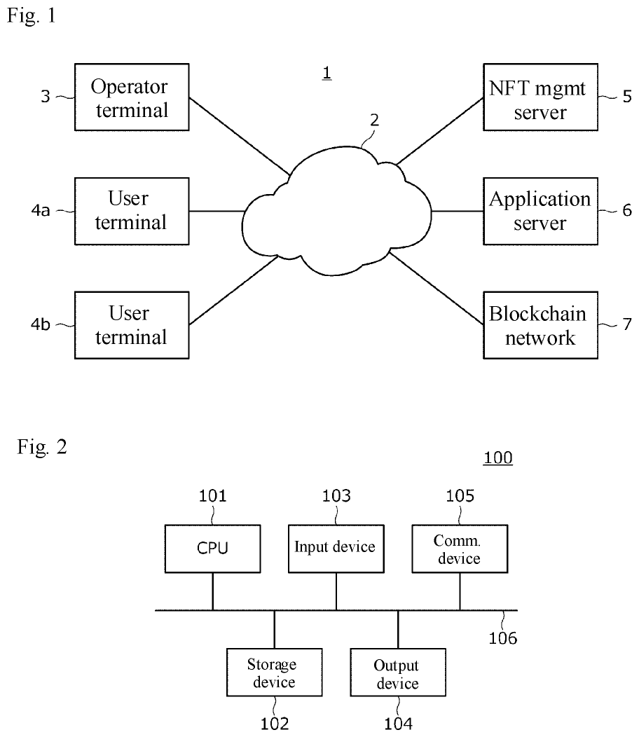

FIG. 1 illustrates a configuration of the card ownership management system 1 according to the present embodiment. As shown in FIG. 1, the card ownership management system 1 has a configuration in which an operating terminal 3, a plurality of user terminals 4a and 4b, a non-fungible token (NFT) management server 5, an application server 6, and a blockchain network 7 are mutually connected via a network 2.

The operating terminal 3 is a terminal in which a person in charge of operators of the card ownership management system 1 operates. In addition, the user terminals 4a and 4b are terminals for the user of the card ownership management system 1 to operate. Further, FIG. 1 shows only two user terminals 4a and 4b, but the actual card ownership management system 1 may include more user terminals. Hereafter, when there is no need to particularly distinguish between the user terminals 4a and 4b, they may be collectively referred to as “user terminal 4”. The NFT management server 5 and the application server 6 are web servers installed and managed by an operator of the card ownership management system 1 in order to operate the card ownership management system 1.

FIG. 2 illustrates an exemplary hardware configuration of the operating terminal 3, the user terminal 4, the NFT management server 5, and the application server 6. The operating terminal 3, the user terminal 4, the NFT management server 5, and the application server 6 may each be configured by a computer 100 having a configuration illustrated in the drawing. In a representative example, the computer 100 that configures the operating terminal 3 and the user terminal 4 is a personal computer such as a personal computer, tablet terminal, or smartphone. Also, the computer 100 that configures the NFT management server 5 and the application server 6 may be a computer configured by combining a plurality of computers.

As shown in FIG. 2, the computer 100 is configured to include a central processing Unit (CPU) 101, storage device 102, input device 103, output device 104, and communication device 105.

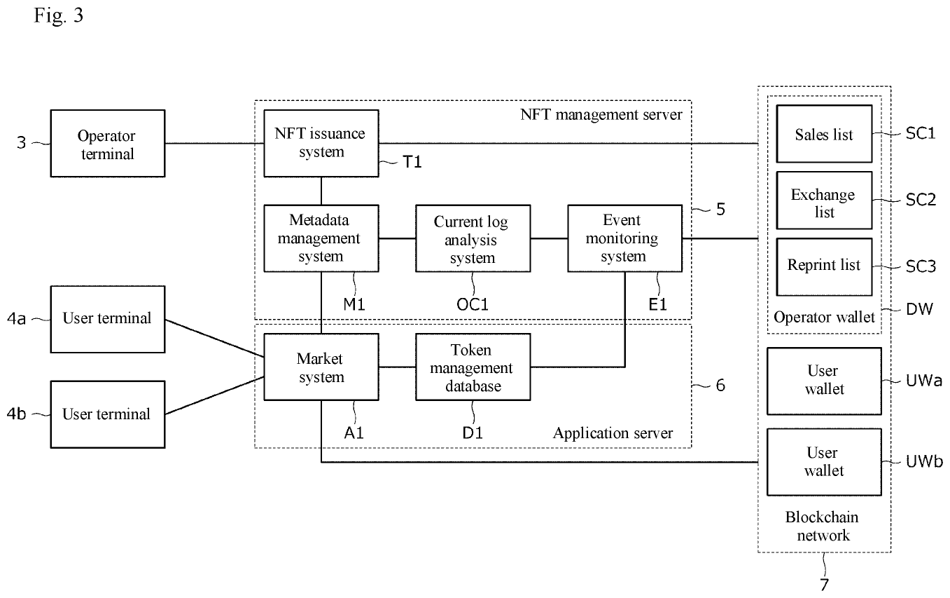

The CPU 101 is a device that controls each component of the computer 100 and retrieves and executes various programs held in the storage device 102. Each process described below with reference to FIGS. 3 to 14 is achieved by executing programs held in the storage device 102 by the CPU 101 of the operating terminal 3, user terminal 4, NFT management server 5, and application server 6.

The storage device 102 includes a main storage device such as a dynamic random access memory (DRAM) and an auxiliary storage device such as a hard disk, and serves to hold various programs for executing the operating system and various applications of the computer 100, and data used by these programs.

The input device 103 is a device that accepts an input operation of the user and supplies to the CPU 101, and is configured to include a keyboard, mouse, and touch panel, for example. The output device 104 is a device that outputs processing results of the CPU 101 to the user, and is configured to include a display and a speaker, for example. The communication device 105 is a device for communicating with an external device and transmits and receives data according to instructions from the CPU 101. The operating terminal 3, user terminal 4, NFT management server 5, and application server 6 each use this communication device 105 to communicate between other devices, systems, and networks including the blockchain network 7 illustrated in FIG. 1.

Back to FIG. 1. The blockchain network 7 is a network of several computers connected via a peer-to-peer, and is configured to record a smart contract transaction into the blockchain. In general, there are three types of blockchain: a public chain where there is no specific administrator, a private chain which is administered by a single organization, and a consortium chain which is administered by a plurality of organizations, and the blockchain network 7 may be any of these types. In a representative example, the blockchain network 7 is either an Ethereum network classified as the public chain or a LINE blockchain classified as the private chain. The description below continues with the blockchain network 7 being the Ethereum network.

Recording a transaction in the blcokchain is executed by some computers (hereafter referred to as “miners”) connected to the blockchain network 7. Specifically, each block configuring the blockchain is configured to include a block header and data (transaction data) that shows specific contents of the transaction. The block header among them includes a Merkle Root which is data obtained by compressing the size of the transaction data, a hash value of the previous block, and a nonce value which is an arbitrary character string. The blockchain network 7 has a rule that a hash value of the block must satisfy a predetermined condition (for example, a condition where a value starts with “000”) in order to connect anew block to the block chain. Given this, the miner trying to record the block in the blockchain performs mining, that is, to find a nonce value in a brute force way such that a hash value of the block header of the block satisfies the predetermined condition above. As a result of this work, the miner who succeeds in discovering the nonce value the earliest links the block to the blockchain, and thus completes recording of the transaction into the blockchain.

When the blockchain network 7 is the Ethereum network, a person trying to record the transaction into the blockchain needs to pay a fee called a “gas” in virtual currency. The gas is paid as compensation to the miner who succeeds in linking the block.

FIG. 3 is a schematic block diagram illustrating a functional block of the NFT management server 5 and the application server 6. In FIG. 3, the operating terminal 3, user terminal 4, blockchain network 7 are also illustrated, and further an operator wallet DW and user wallets UWa and UWb that are provided in the blockchain network 7 are illustrated.

Each of the operator wallet DW and user wallets UWa and UWb is a virtual storage device for managing non-fungible tokens (hereafter referred to as “card tokens”) that function as trading cards. The non-fungible token, in general, is a unit of data on the blockchain and includes a function to provide a proof of ownership of a person who has purchased the non-fungible token. In the present embodiment, since this non-fungible token is used as the trading card, unlike the digital trading card described above, it is possible to give the ownership of the trading card that is converted to the digital card to the user.

The operator wallet DW plays a role of managing card tokens reserved by an operator of the card ownership management system 1 and each of the user wallets UWa and UWb performs a role of managing card tokens reserved by the user of the user terminals 4a and 4b. Hereafter, when there is no need to particularly distinguish between the user wallets UWa and UWb, they may be collectively referred to as a “user wallet UW”.

As shown in FIG. 3, the NFT management server 5 is configured to functionally include a NFT issuance system T1, a matadata management system M1, an event monitoring system E1, and a current log analysis system OC1. Further, the application server 6 is configured to functionally include a market system 1A and token management database D1.

The NFT issuance system T1 is a functional section that issues anew card token. The card token issued by the NFT issuance system T1 is a non-fungible token that indicates a trading card and is configured to include information such as a theme, type, card type, issue date, information indicating an operator (name and the like), Uniform Resource Locator (URL) of the trading card image, rarity (information indicating a rank of the trading card).

Among the information included in the card token noted above, the “theme” is information to specify the theme of trading cards such as a “J-league chips” and “Pocket Monsters”. Also, the “type” is information to specify contents (such as design, character) subdividing the “theme”.

The “card type” is information indicating whether the card token is for sale to users (hereafter referred to as a “card token for sale”) or the card token is for exchange with another card token reserved by the user (hereafter referred to as a “card token for exchange”). In the card token for exchange, information indicating one or more card tokens required for exchange is also included.

The “trading card image” is an image data showing the “type” and plays a role to allow the user to specify the “type” of the card token. The URL of the trading card image is an address to access the trading card image via the network 2 illustrated in FIG. 1. As an example, the trading card image is stored in the token management database D1, and the address in this case is information indicating a location in the token management database D1.

The issuance of the card token by the NFT issuance system T1 is performed based on an issuance instruction from the operating terminal 3. The issuance instruction includes a theme and type of the card token to be issued, and information to specify the card type, the number of units to be issued, the number of tokens to be issued (maximum number to be issued), the URL of the trading card image, and rarity. When the card type of the card token to be issued is the card token for exchange, information indicating one or more card tokens required for exchange is also included in the issuance instruction.

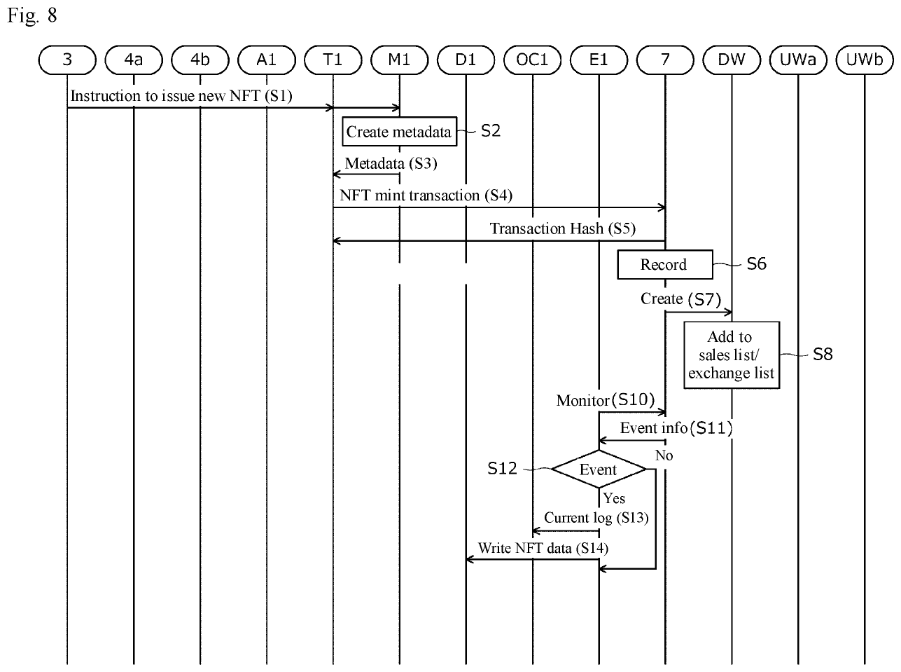

Specifically describing a process of issuing the card token, the NFT issuance system T1 first decides to issue only the number of card tokens of the type specified by the issuance instruction that was received, as indicated by the number of units included in the received issuance instruction. Then, the NFT issuance system T1 creates a smart contract transaction (hereafter referred to as “NFT mint transaction”) indicating creation of one or more new card tokens to be issued and records the transaction in the blockchain network 7, and also performs adding of one or more issued cards tokens to the operator wallet DW Details of the above processes are described again below in more detail with reference to FIG. 8.

As shown in FIG. 3, the operator wallet DW includes a sales list SC1 holding a plurality of card tokens for sale, an exchange list SC2 holding a plurality of card tokens for exchange, and a reprint list SC3 temporarily holding the tokens to be reprinted. The NFT issuance system T1 is configured to add the newly issued card tokens for sale to the sales list SC1 and the newly created card tokens for exchange to the exchange list SC2 respectively.

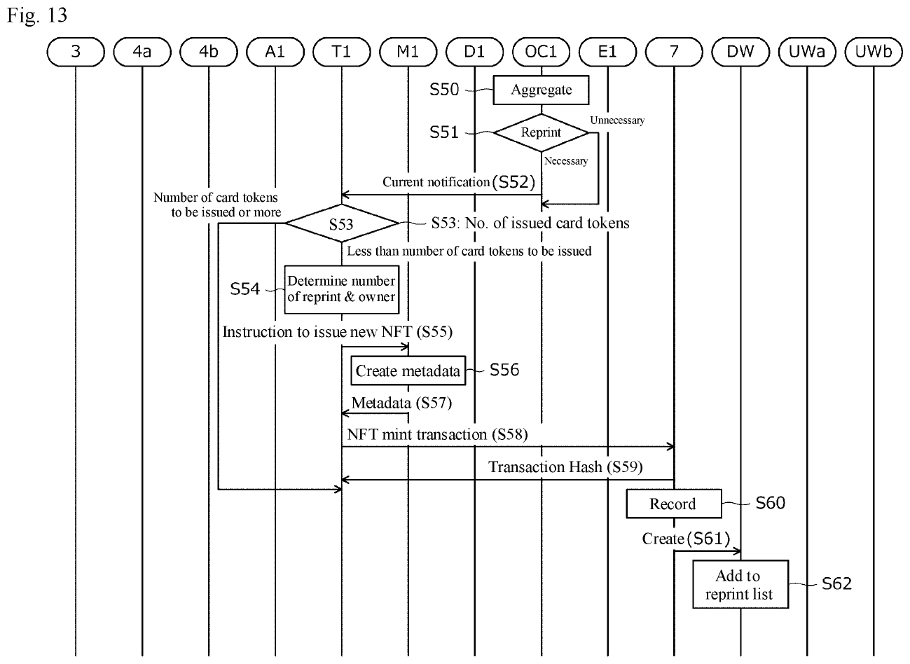

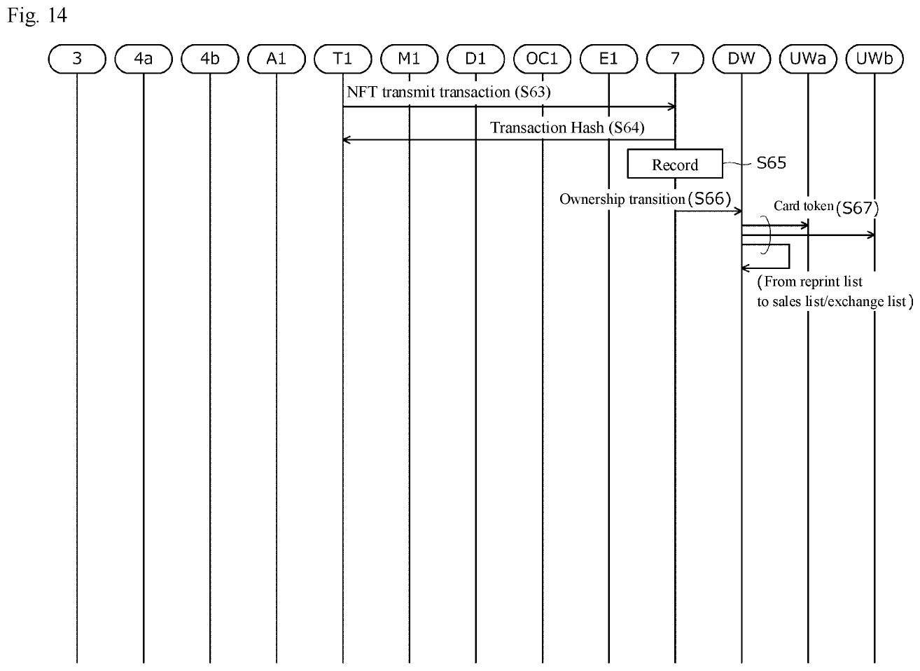

In addition, the NFT issuance system T1 also processes reprinting of the card tokens in response to a notification from the current log analysis system OC1 (described below) until the number of issued card tokens reaches the number of tokens to be issued included in the issuance instruction. In this case, the NFT issuance system T1 is configured to add the reprinted card token to the reprint list SC3. The card token added to the reprint list SC3 becomes subjected to sale, exchange, and trading between users by being moved to the sales list SC1, the exchange list SC2, or the user wallet UW Details of the process for reprinting card token are described later with reference to FIGS. 13 and 14.

The metadata management system M1 is a functional section that manages metadata of the card token and notifies the metadata to the NFT issuance system T1 in response to the issuance instruction supplied from the NFT issuance system T1. The NFT issuance system T1 issues or reprints the card token based on the metadata notified in this way also. The specific contents of the metadata managed by the metadata management system M1 are set in the metadata management system M1 from the operating terminal 3 by the issuance instruction or other notification described above.

The metadata that is set in the metadata management system M1 by the issuance instruction includes information indicating the number of units to be issued, the number of tokens to be issued, the URL of the trading card image, rarity, and one or more card tokens required for exchange for each type. The metadata management system M1 holds this information for each type and supplies a portion of the metadata to the NFT issuance system T1 when the NFT issuance system T1 reprints the card token.

On the other hand, the metadata that is set in the metadata management system M1 by the other notification includes information indicating the operator. The metadata management system M1 supplies this information as a portion of metadata to the NFT issuance system T1 when the NFT issuance system T1 reprints or issues a new card token.

The event monitoring system E1 is a functional section that detects occurrence of an event in the blockchain network 7 by monitoring the blockchain network 7. Specifically, by checking periodically the card tokens managed by the operator wallet DW and the user wallet UW respectively, the occurrence of an event related to card tokens such as issuance of card tokens or moving between wallets are detected. The event monitoring system E1 obtains, when detected an event, event information indicating contents of the detected event from the blockchain network 7. Then, while history data of the obtained event information (hereafter referred to as “current log”) is supplied to the current log analysis system OC1, the data showing the movement of card tokens indicated in the obtained event information (hereafter referred to as “NFT data”) is supplied to the token management database D1.

The current log analysis system OC1 is a functional section that aggregates data related to transactions such as the number of issuance, number of movement, and transaction prices for every type of card tokens based on the current log supplied by the event monitoring system E1, and calculates the current of the card tokens for each type based on the aggregated results. When the current of card tokens calculated for a certain type falls below a predetermined threshold previously held (that is, when the current is underperformed), the current log analysis system OC1 also notifies the NFT issuance system T1 to that effect. Upon receiving this notification, the NFT issuance system T1 determines whether the number of corresponding issued card tokens reaches the number of tokens to be issued, and reprints the corresponding card tokens if not reached.

More specifically, the current of the card token is a transaction price between the users. In this case, when the transaction price between the users for a certain type of card token exceeds a predetermined threshold, the current log analysis system OC1 determines that the current of the type is underperformed and notifies the NFT issuance system T1 to that effect. Doing this results in reprinting the card tokens with soaring transaction price and keeping the transaction price low.

The token management database D1 is a database that manages card tokens based on NFT data supplied from the event monitoring system E1. Specifically, the token management database D1 is configured to duplicate and hold the operator wallet DW and the user wallet UW, and to hold the number of respective issued card tokens. As described above, the token management database D1 may also store the trading card images.

In addition, the token management database D1 also plays a role to hold the token set information that includes sales units of card tokens and combined information that is a combination of predetermined card token types. The token set information includes a plurality of combinations of one or more card tokens configuring a token set and a price of each token set respectively. The combined information includes a plurality of combinations of card token configuring each combo. The token set information and combined information are set to the token management database D1 from the operating terminal 3.

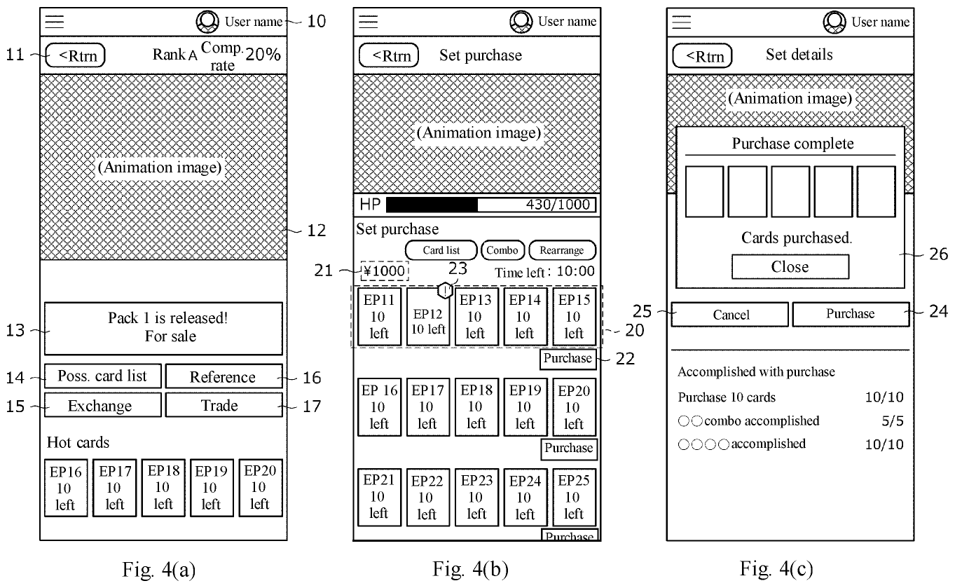

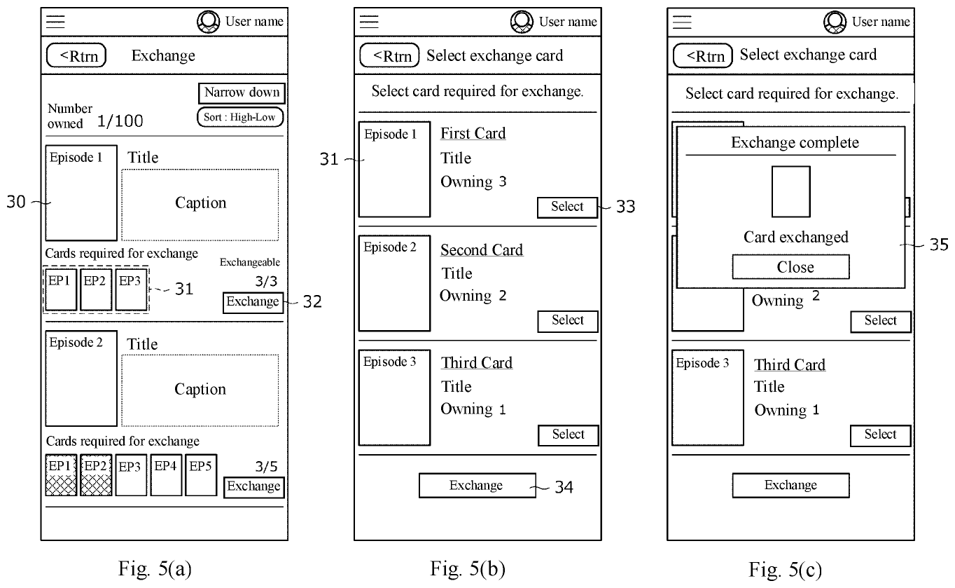

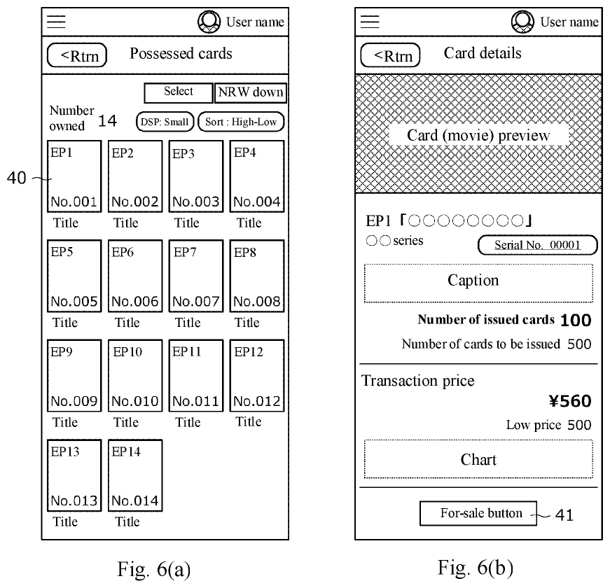

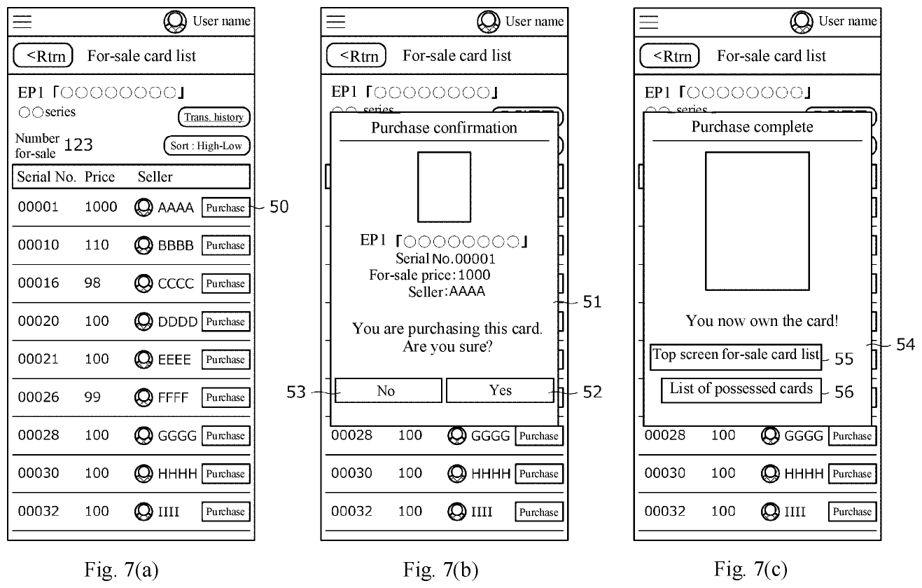

The market system A1 is a functional section that provides to the user terminal 4 the interface to access the wallet held in the token management database D1. This interface includes a first interface for the user to purchase the card token for sale, a second interface to exchange the card token for exchange with the card token held in the user wallet UW, and a third interface for trading the card token held in the user wallet UW between the users. An example of the first interface in FIG. 4, an example of the second interface in FIG. 5, and an example of the third interface in FIGS. 6 and 7 are illustrated respectively, and described below.

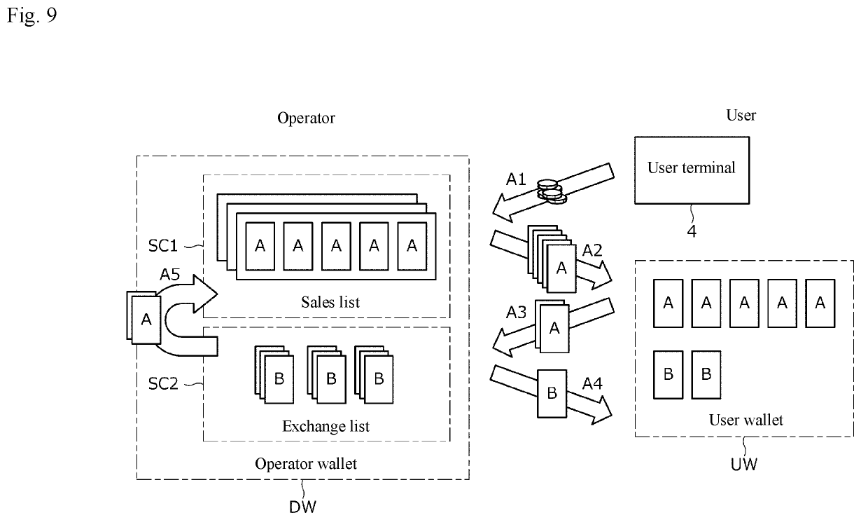

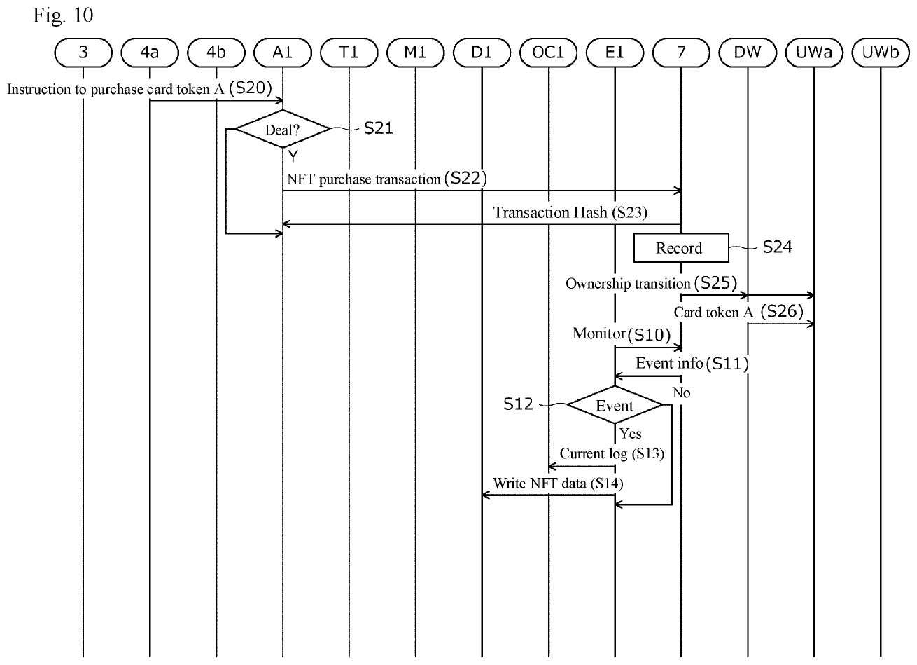

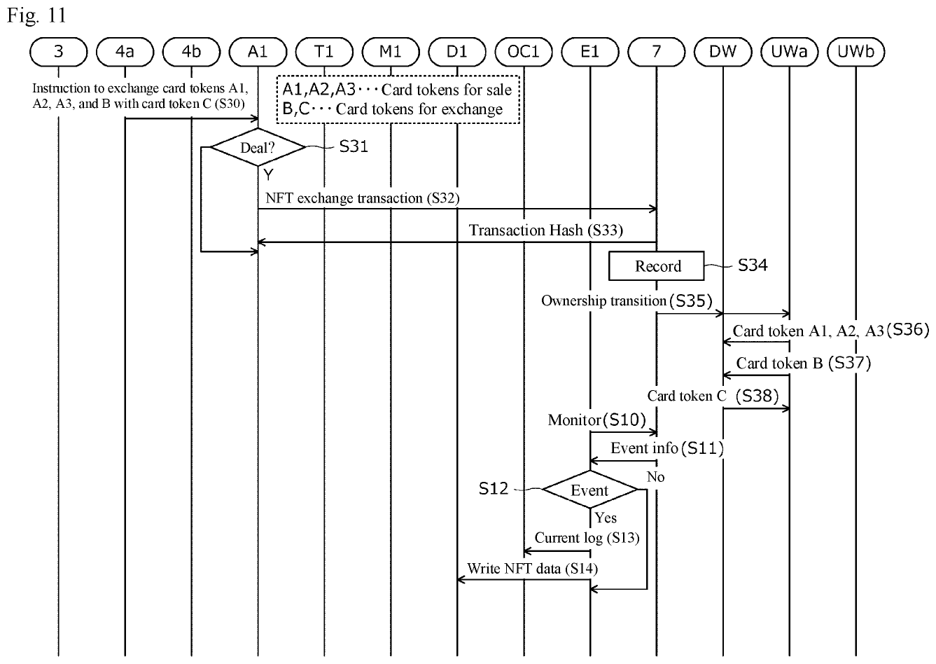

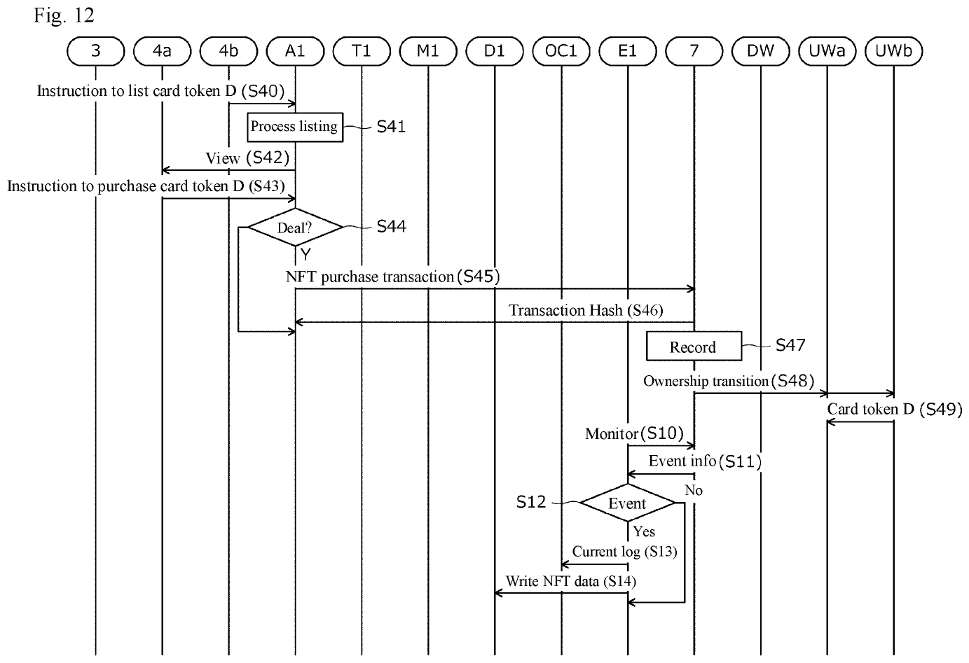

In addition, the market system A1 also functions as a backend of each interface and is configured to execute a process of purchasing the card token, a process of exchanging the card token, and a process of trading the card token between the users. The details of the process of purchasing the card token are described in FIGS. 9 and 10, the details of the process of exchanging the card token are described in FIGS. 9 and 11, and the details of the process of trading the card token between the users are described in FIG. 12 below with reference to the drawings respectively. In order to execute the process of trading the card token between the users, the market system A1 also plays a role to hold a for-sale list that stores information of card tokens that users have put on the market to sell to other users.

FIGS. 4 to 7 illustrate exemplary screens displayed on the user terminal 4 that is a smartphone. Any of the screens illustrated in each drawing is created by the application executed by the user terminal 4 in collaboration with the market system A1. Hereafter, a summary of a process performed by the card ownership management system 1 is described with reference to these figures.

FIGS. 4(a) to 4(c) shows screens configuring the first interface described above. FIG. 4(a) is a top screen of the card ownership management system 1, which is configured to include a display of a user information 10, a return button 11, a display of an animation image 12, and operation buttons 13 to 17.

The user information 10 is the information of the user who is logged in to the application, and as shown in the drawing, is configured to include an icon (or a picture) of the user and a name of the user. Not displayed, but the user information 10 further also includes the information about a payment method of the user (for example, virtual currency wallet or credit card information). Although not shown in the drawings, a log-in button is displayed instead of the user information when the user is not logged in, and the user information 10 is displayed when the user presses the log-in button to log in. Specific contents of the user information 10 are registered in advance by the user in the application. The return button 11 is a button to transition to a previous screen. The user information 10 and the return button 11 configure a global navigation and are displayed similarly on each screen described below.

The animation image 12 is a video or a still image illustrating the “theme” of the card token described above. In this example, the “theme” of the card token handled in the same application preferably remains constant. By doing so, the user can understand the theme of the trading card handled by the currently running application from the animation image 12.

The operation button 13 is a button to transition to, in response to a pressing operation from the user, a screen to purchase the token set (see FIG. 4(b)). The pressing operation of the operation button 13 is specifically realized by tapping or clicking. This point also applies to other buttons described below. In FIG. 4(a), the surface of the operation button 13 shows “Pack 1 is released! For sale”, but this is an advertisement to promote the user to purchase.

The operation button 14 is a button to transition to, in response to the pressing operation from the user, a screen of the card token list that is already possessed by the user (see FIG. 6(a)). The operation button 15 is a button to transition to, in response to the pressing operation from the user, an exchange screen (see FIG. 5(a)) to exchange the card token already possessed by the user with the card token held in the exchange list SC2. The operation button 16 is a button to transition to, in response to the pressing operation from the user, an illustrated reference screen (not shown in the drawing) that describes the issued tokens like an illustrated reference book. The operation button 17 is a button to transition to, in response to the pressing operation from the user, a screen of the card token list that is put up for sale by the other user (see FIG. 7(a)).

FIG. 4(b) is a screen to purchase the displayed card tokens when the user presses the operation button 13 in FIG. 4(a), which is configured to include a display of a plurality of token sets 20, a display of price 21, a plurality of purchase buttons 22 provided for each token set 20, and a combo badge 23.

The token set 20 is a token set held in the token management database D1. FIG. 4(b) shows an example of one token set 20 configured with five card tokens for sale. In addition, the price 21 is a price of the token set 20 held in the token management database D1. In order to display this information on the screen to purchase, the market system A1 obtains information of token set 20 from the token management database D1. Then, the trading card image of each card token for sale is obtained by referring to the URL included in each card token for sale that configures the token set 20 indicated by the obtained information, and the various obtained trading card images are displayed on the screen to purchase for every token set 20 in order. In addition, the price of the token set 20 is retrieved from the obtained information of the token set 20 and is displayed as the price 21. FIG. 4(b) shows a case where the price of the plurality of token sets 20 being displayed are all 1,000 yen.

In this example, as exemplified in FIG. 4(b), in each of the trading card images, a display of “remaining number of cards is X” indicating the number of card tokens of the same type held in the sales list SC1 may be added. Doing this results in promoting the users to purchase card tokens early.

The purchase button 22 is a button to transition to, in response to the pressing operation from the user, a screen to purchase the corresponding token set 20 (see FIG. 4(c)). The combo badge 23 is a small-size image that is displayed overlapping on the trading card image and indicates that the combo noted above is established when the corresponding card token is purchased. The market system A1 obtains the combo information by accessing to the token management database D1 in order to display this combo badge 23, and further detects the combination of card tokens that establishes the combo with one more card purchase by accessing the user wallet UW of the user who is logged-in. Then, the combo badge 23 is added to the trading card image of the card token required to establish the combo related to the combination.

FIG. 4(c) is a screen to purchase the token set 20 that is displayed by the user pressing the purchase button 22 in FIG. 4(b), which is configured to include a purchase button 24 and a cancel button 25. The purchase button 24 among them is a button to execute, in response to the pressing operation from the user, the process of purchasing the token set 20. When the user presses the purchase button 24, the market system A1 moves the plurality of card tokens that configures the purchased token set 20 from the sales list SC1 to the user wallet UW. And, when this move was successful, a purchase completion window 26 shown in the drawing is displayed to notify the user that the purchase of the token set 20 is made. Inside the purchase completion window 26, the trading card images for various card tokens configuring the purchased token set 20 are arranged. When the user presses the cancel button 25, the market system A1 brings back the screen to purchase illustrated in FIG. 4(b) without executing the moving process noted above.

FIGS. 5(a) to 5(c) show screens configuring the second interface described above. FIG. 5(a) is the exchange screen displayed when the user presses the operation button 15 in FIG. 4(a), which is configured to include a display of a plurality of card tokens for exchange 30, a display of one or more card tokens 31 required for the respective exchange, and a plurality of exchange buttons 32 provided for each card token for exchange 30.

When the exchange screen is displayed, the market system A1 obtains information on the card token for exchange 30 from the exchange list SC2 in the token management database D1. Then, the trading card image is obtained by referring to the URL included in the card token for exchange 30 indicated by the obtained information, and the obtained trading card image is displayed on the exchange screen. As illustrated in FIG. 5(a), the title and caption of the card token for exchange 30 may further be displayed. In this case, this information is prearranged inside the card token for exchange 30.

In addition, the market system A1 retrieves information on one or more card tokens 31 required for exchange from the card token for exchange 30 obtained from the exchange list SC2, and obtains one or more trading card images by referring to the URL included in each of the one or more card tokens 31 indicated by the retrieved information. Then, the obtained one or more trading card images are displayed side by side at a position adjacent to the trading card image of the corresponding card token for exchange 30 on the exchange screen.

The market system A1 further determines whether each of the one or more card tokens 31 required for exchange is included in the user wallet UW of the user who is logged-in, and displays the number included, and further displays “exchange available” when all are included. In addition, the trading card image corresponding to the card token 31 which is not included in the user wallet UW of the user who is logged-in is cross-hatched to notify the user that the user does not have the card token 31 and exchange is not available.

The exchange button 32 is a button to transition to, in response to the pressing operation from the user, an exchange card selection screen to have the user select a card token to be actually exchanged with the corresponding card token for exchange 30. In a case where a certain type of card token must be presented in exchange for the corresponding card token for exchange 30, when the user has multiple card tokens of that type, the user needs to select one from the multiple card tokens possessed by the user before the market system A1 executes the exchange process. The exchange card selection screen is provided to achieve such selection.

FIG. 5(b) is an exchange card selection screen displayed when the user presses the exchange button 32 in FIG. 5(a), which is configured to include a display of one or more card tokens 31, one or more select buttons 33 provided for each card token 31, and an exchange button 34. In the exchange card selection screen, the trading image, title, and the number owned by the user are displayed for each card token 31.

The select button 33 is a button to display, in response to the pressing operation from the user, a selection window (not shown in the drawing) configured so as to be able to select one from the card token of the same type as the corresponding card token 31 from among one or more card tokens possessed by the user. In this selection window, when the user selects the card token, the selection window disappears and the exchange card selection screen is brought back in FIG. 5(b). In the exchange card selection screen in this case, information (not shown) specifying the selected card token in the selection window may be displayed.

The exchange button 34 is a button to execute, in response to the pressing operation from the user, a process of exchanging the card token for exchange 30. When the user presses the exchange button 34, the market system A1 first determines whether the user made the selections for all card tokens 31. When there are unselected card tokens 31 left, a message indicating to that effect is displayed and the exchange card selection screen is brought back. On the other hand, when the user has selected all card tokens 31, all card tokens selected by the user are moved to the operator wallet DW from the user wallet UW and the corresponding card tokens for exchange 30 are moved to the user wallet UW from the exchange list SC2. The card tokens 31 moved to the operator wallet DW are respectively added to the sales list SC1 when they are card tokens for sale, and to the exchange list SC2 when they are card tokens for exchange. Then, the market system A1 displays an exchange completion window 35 illustrated in FIG. 5(c) when these moves are successful, and notifies the user that the exchange to the card tokens for exchange 30 is made. In the exchange completion window 35, the trading card image of the corresponding card token for exchange 30 is arranged.

FIG. 6(a), FIG. 6(b) and FIGS. 7(a) to 7(c) show screens configuring the third interface described above. FIG. 6(a) is a card possession screen displayed when the user presses the operation button 14 in FIG. 4(a), the screen displaying a list of trading card images of all card tokens 40 held in the user wallet UW of the user logged-in. Each trading card image is a link to a card detail screen, and when the user presses any trading card image, the market system A1 displays the detail screen of the corresponding card token 40 on the user terminal 4.

FIG. 6(b) is the card detail screen displayed when the user presses the trading card image in FIG. 6(a), which is configured to include a display of various information related to the corresponding card token and a for-sale button 41. As shown in FIG. 6(b), the various information include the number of issued card tokens (issued number), the number to be issued, and information indicating the transaction price of the card tokens between users. The information indicating the transaction price among these is information obtained by the current log analysis system OC1 based on the current log, and is configured to include the latest transaction price, the lowest transaction price to date (low price), and a chart showing fluctuations of the transaction price, as shown in FIG. 6(b).

The for-sale button 41 is a button to put the card tokens on the market for the purpose of selling to other users. When the user presses the for-sale button 41, the market system A1 displays an input window (not shown) for assigning a for-sale price. In this input window, when the user enters the for-sale price, the market system A1 adds the corresponding card token and the for-sale price of the card token to the for-sale list that is held. Accordingly, the corresponding card token and the for-sale price of the card token are displayed on a screen of for-sale card list described below.

FIG. 7(a) is the screen of for-sale card list displayed when the user presses the operation button 17 in FIG. 4(a), which is configured to include a list of card tokens included in the for-sale list, a plurality of purchase buttons 50 provided for each card token in the list. When the user presses the purchase button 50, the market system A1 displays a purchase confirmation window 51 illustrated in FIG. 7(b). The purchase confirmation window 51 is a window to confirm an intention to purchase the corresponding card token, which displays information of the corresponding card token and the for-sale price of the card token and includes a yes button 52 and a no button 53.

When the user presses the no button 53 in the purchase confirmation window 51, the market system A1 erases the purchase confirmation window 51 and brings back the screen of for-sale card list in FIG. 7(a). On the other hand, when the user presses the yes button 52 on the purchase confirmation window 51, the market system A1 moves the corresponding card token to the user wallet UW of a buyer from the user wallet UW of a seller. And, when this move is successful, a purchase completion window 54 shown in FIG. 7(c) is displayed to notify the user that the purchase is made.

As illustrated in FIG. 7(c), the purchase completion window 54 is configured to include two operation buttons 55 and 56 in addition to the trading card image of the purchased card token. The operation button 55 is a button to transition to, in response to the pressing operation from the user, the screen of for-sale card list illustrated in FIG. 7(a). When the user presses the operation button 55, the market system A1 again displays the screen of for-sale card list illustrated in FIG. 7(a). On the screen of for-sale card list displayed at this time, the card token that has just been purchased is gone. The operation button 56 is a button to transition to, in response to the pressing operation from the user, the card possession screen illustrated in FIG. 6(a). When the user presses the operation button 56, the market system A1 again displays the card possession screen illustrated in FIG. 6(a). On the card possession screen displayed at this time, the card token that has just been purchased is added.

The above overview of the processes performed by the card ownership management system 1 is described with reference to the exemplary screens displayed on the user terminal 4. Next, processes performed by the card ownership management system 1 is described in detail with reference to FIGS. 8 to 14.

FIG. 8 is a sequence diagram illustrating the processes of issuing the new card token. When issuing a new card token, the operating terminal 3 first supplies the NFT issuance system T1 with the issuance instruction described above (step S1). The NFT issuance system T1 transmits the supplied issuance instruction to the metadata management system M1, and the metadata management system M1 creates metadata described above based on the information included in the transmitted issuance instruction (step S2) and supplies the metadata to the NFT issuance system T1 (step S3).

The NFT issuance system T1 that has received the metadata creates the smart contract transaction (NFT mint transaction) indicating creation of the new card token and sends to the blockchain network 7 (step S4). The blockchain network 7 that has received the NFT mint transaction first returns a Transaction Hash to the NFT issuance system T1 (step S5). Next, the mining described above is performed in the blockchain network 7, and the NFT mint transaction is recorded in the blockchain (step S5). When recording is completed, the blockchain network 7 creates a card token on the operator wallet DW (step S7). The card token created in this way is added respectively to the sales list SC1 when the card token is for sale and to the exchange list SC2 when the card token is for exchange (step S8), thereby completing the process for issuing the new card token.

The event monitoring system E1 monitors the occurrence of the event in the blockchain network 7 as described above (step S10), and periodically determines whether an event has occurred (step S12). In the example of FIG. 8, the card token is added to the operator wallet DW in step S8, and therefore, the event monitoring system E1 obtains, as a result of monitoring, the event information indicating that the card token is added to the operator wallet DW from the blockchain network 7 (step S11) and determines as “yes” in step S12. When the result is determined in step S12 as “yes”, the event monitoring system E1 writes the current log including the obtained event information to the current log analysis system OC1 (step S13) and writes NFT data indicating the movement of the card token indicated in the obtained event information to the token management database D1 (step S14).

Next, the process of purchasing and exchanging the card tokens is described. First, FIG. 9 is a diagram describing a general flow of purchasing and exchanging the card tokens. In FIG. 9, rectangles marked “A” indicates the card tokens for sale and rectangles marked “B” indicates the card tokens for exchange. Further, arrows A1 to A5 illustrated in FIG. 9 indicate the order of the process.

In the initial state, as shown in FIG. 9, a plurality of card tokens for sale are stored in the sales list SC1 and a plurality of card tokens for exchange are stored in the exchange list SC2 respectively. First, the user purchases the card tokens for sale by using the user terminal 4. At this time, the user pays the operator for the card tokens for sale (arrow A1). What is actually paid for the process of the arrow A1 is typically the virtual currency managed by the blockchain network 7 (e.g., Ethereum for the Ethereum network, LINK for the LINE blockchain), however, other virtual currency or legal currency such as yen or dollars may also be used. When the payment is completed, the operator moves the purchased card tokens for sale to the user wallet UW from the sales list SC1 (arrow A2). Accordingly, the user acquires ownership of the purchased card tokens for sale. In FIG. 9, five card tokens for sale are moved to the user wallet UW from the sales list SC1 in the process of the arrow A2, which corresponds to the token set described above.

Next, the user who wants the card tokens for exchange sends the operator one or more card tokens required to exchange with the card tokens for exchange (one of the card tokens for sale and the card tokens for exchange, or the combination thereof) (arrow A3). The operator who has received one or more tokens from the user in this way moves the card tokens for exchange corresponding to the received one or more tokens from the exchange list SC2 to the user wallet UW (arrow A4), and the card tokens for sale among the received one or more tokens are stored in the sales list SC1 (arrow A5), and the card tokens for exchange are stored in the exchange list SC2. Exchange is completed with the process noted above and the user acquires ownership of the card tokens for exchange. In addition, the operator can make a profit by reselling the received card tokens or exchanging with the user's card tokens.

FIG. 10 is a sequence diagram illustrating the process of purchasing the card token. FIG. 10 shows a case where the user of the user terminal 4a makes a purchase, but the same applies when the other user makes a purchase. First, in the user terminal 4a, the user executes an operation to instruct a purchase of a card token A that is a card token for sale. Specifically, this operation is pressing the purchase button 22 illustrated in FIG. 4(c). Upon receiving this operation, the user terminal 4a sends an instruction to purchase the card token A to the market system A1 (step S20). In this purchase instruction, the information specifying the card token Ato be purchased and the information about the payment method (for example, virtual currency wallet or credit card information) are included.

The market system A1 that has received the purchase instruction determines whether the instructed purchase is made (step S21). This determination includes a determination of whether the payment of the required amount can be made by user's payment method. The required amount is the amount required to purchase the token set and is equal to the price of the token set, given that the blockchain network 7 does not request a fee such as gas described above for recording the transaction. On the other hand, when the blockchain network 7 does not request a fee such as gas described above for recording the transaction, the above required amount is the amount obtained by adding the fee to the price of the token set. The determination of whether the payment can be made is, for example, a determination whether there is enough balance in the user's virtual currency wallet when the user intends to pay with the virtual currency, or a determination whether the online payment is completed when the user intends to pay with a credit card. The market system A1 determines that the instructed purchase is made when the required amount can be paid by the user's payment method.

The market system A1 that has determined that the purchase is made generates a smart contract transaction (NFT purchase transaction) indicating the purchase of the card token A, and sends to the blockchain network 7 (step S22). The blockchain network 7 that has received the NFT purchase transaction first returns a Transaction Hash to the market system A1 (step S23). Next, the mining described above is performed in the blockchain network 7, and the NFT purchase transaction is recorded in the blockchain (step S24). When the recording is completed, the blockchain network 7 performs the ownership transition of the card token A in the operator wallet DW and the user wallet UWa (step S25). Accordingly, the card token A is moved from the sales list SC1 of the operator wallet DW to the user wallet UWa (step S26) and the process of purchasing is completed. Thereafter, when the processes of steps S10 to S14 described with reference to FIG. 8 are performed, the current log indicating that the card token A being purchased is written to the current log analysis system OC1 and the NFT data indicating the movement of the card token A is written to the token management database D1, respectively.

FIG. 11 is a sequence diagram illustrating the process of exchanging the card token. FIG. 11 shows a case where the user of the user terminal 4a exchanges a card token, but the same applies when the other user exchanges a card token. First, in the user terminal 4a, the user executes an operation to instruct an exchange between card tokens A1, A2, A3, and B with a card token C. Specifically, this operation is pressing the exchange button 34 illustrated in FIG. 5(b). In addition, as described in FIG. 11, the card tokens A1, A2, and A3 are the card tokens for sale, and the card tokens B and C are the card tokens for exchange. Upon receiving this operation, the user terminal 4a sends an exchange instruction to the market system A1 (step S30). In this exchange instruction, the information specifying the card tokens A1, A2, A3, and B that are offered by the user and the information specifying the card token C that the user is seeking is included. When the blockchain network 7 requests the fee for recording the transaction, the exchange instruction also includes the information about the payment method (for example, virtual currency wallet or credit card information).

The market system A1 that has received the exchange instruction determines whether the instructed exchange is made (step S31). This determination includes a determination of whether one or more card tokens required for exchange with the card token C match the card tokens A1, A2, A3, and B. The market system A1 determines that the instructed exchange is made when it is determined that the one or more card tokens required for exchange with the card token C match the card tokens A1, A2, A3, and B. Further, when the blockchain network 7 requests a fee such as gas described above for recording the transaction, this determination includes a determination of whether the payment of the required amount can be made by user's payment method. The market system A1 determines that the instructed exchange is made when the required amount can be paid by the user's payment method.

The market system A1 that has determined the exchange is made creates a smart contract transaction (NFT exchange transaction) indicating the exchange between the card tokens A1, A2, A3, and B with the card token C, and sends it to the blockchain network 7 (step S32). The blockchain network 7 that has received the NFT exchange transaction first returns a Transaction Hash to the market system A1 (step S33). Next, the mining described above is performed in the blockchain network 7, and the NFT exchange transaction is recorded in the blockchain (step S34). When the recording is completed, the blockchain network 7 performs the ownership transition of the card tokens A1, A2, A3, B, and C in the operator wallet DW and the user wallet UWa (step S35). Accordingly, the card tokens A1, A2, and A3 are moved from the user wallet UWa to the sales list SC1 of the operator wallet DW; the card token B is moved from the user wallet UWa to the exchange list SC2 of the operator wallet DW; and the card token C is moved from the exchange list SC2 of the operator wallet DW to the user wallet UWa, respectively (steps S36 to S38); and the process of exchanging is completed. Thereafter, when the processes of steps S10 to S14 described with reference to FIG. 8 are performed, the current log indicating the exchange between the card tokens A1, A2, A3, and B with the card token C is written to the current log analysis system OC1 and the NFT data indicating the movement of the card tokens A1, A2, A3, B and C is written to the token management database D1, respectively.

Next, FIG. 12 is a sequence diagram illustrating a trading of the card token between the users. FIG. 12 shows a case where the user of the user terminal 4b list a card token D for sale and the user of the user terminal 4a purchases the card token, but the same applies when other users trade card tokens. The card token D that is listed for sale may be either the card token for sale or card token for exchange. First, in the user terminal 4b, the user executes an operation to instruct listing of the card token D for sale. Specifically, this operation is pressing the for-sale button 41 illustrated in FIG. 6(b). Upon receiving this operation, the user terminal 4b sends the listing instruction of the card token D to the market system A1 (step S40). In this listing instruction, the information specifying the card token D that is listed for sale and the information indicating the for-sale price is included.

The market system A1 that has received the listing instruction performs listing of the card token D (step S41). Specifically, the listing process is a process of adding the information of the card token D to the for-sale list described above. When the listing process is completed, each user can check the information of the card token D on the screen of for-sale card list illustrated in FIG. 7(a). When the user of the user terminal 4a views the screen of for-sale card list (step S42) and performs an operation to instruct purchasing of the card token D, the user terminal 4a sends an instruction to purchase the card token D to the market system A1 (step S43). In this purchase instruction, the information specifying the card token D to be purchased and information about the payment method is included.

The market system A1 that has received the purchase instruction determines whether the instructed purchase is made (step S44). Details of this determination are the same as the determination in step S21 illustrated in FIG. 10, except that the for-sale price of the card token D is subject to the determination instead of the price of the token set.

The market system A1 that has determined the purchase is made in the step S44 creates a smart contract transaction (NFT purchase transaction) indicating the purchase of the card token D (trading between the users) and sends it to the blockchain network 7 (step S45). The blockchain network 7 that has received the NFT purchase transaction first returns a Transaction Hash to the market system A1 (step S46). Next, the mining described above is performed in the blockchain network 7, and the NFT purchase transaction is recorded in the blockchain (step S47). When the recording is completed, the blockchain network 7 performs the ownership transition of the card token D in the user wallets UWa and UWb (step S48). Accordingly, the card token D is moved from the user wallet UWb to the user wallet UWa (step S49) and the process of purchasing is completed. Thereafter, when the processes of steps S10 to S14 described with reference to FIG. 8 are performed, the current log indicating the trading of the card token D between the users is written to the current log analysis system OC1 and the NFT data indicating the movement of the card token D is written to the token management database D1, respectively.

FIGS. 13 and 14 are sequence diagrams illustrating the process of reprinting the card token. The current log analysis system OC1 periodically aggregates the current log written in step S13 in FIG. 12 and the like (step S50) and determines each time whether the conditions for reprinting have been met (step S51). Specifically, as described above, whether or not the current of each card token falls below the predetermined threshold previously held is determined. The current log analysis system OC1 that has determined that the conditions for reprinting have been met for a certain card token sends a notification to the NFT issuance system T1 about the current of the card token (step S52).

Upon receiving this notification, the NFT issuance system T1 determines whether the number of issued card tokens meeting the conditions for reprinting reaches the number of that card token to be issued (step S53). When the NFT issuance system T1 determines that the number has reached at this point, the decision is made not to reprint the card token and the process ends. However, when the NFT issuance system T1 determines that the number has not reached, the NFT issuance system T1 determines the number of reprints based on the number of units to be issued as described above and decides an owner of the reprinted card token (including a distribution of the card token, sales list SC1, exchange list SC2, and user wallet UW) (step S54). The owner of the reprinted card token is preferably the owner of the card token who already owns the same card token. In addition, the number to be distributed to each owner is preferably determined in proportion to the number of ownerships of the same card token.

The NFT issuance system T1 that has performed the step S54 then sends the issuance instruction of the new card token to the metadata management system M1 (step S55). After this, the same processes as in the steps S2 to S7 illustrated in FIG. 8 are performed by each part of the card ownership management system 1 (steps S56 to S61), and the card token is created on the operator wallet DW (step S61). The card token created in this way is added to the reprint list SC3 temporarily (step S62).

Thereafter, as shown in FIG. 14, the NFT issuance system T1 creates a smart contract transaction (NFT transmit transaction) indicating the transmit of the token held in the reprint list SC3 at an appropriate time and sends it to the blockchain network 7 (step S63). The blockchain network 7 that has received the NFT transmit transaction first returns a Transaction Hash to the NFT issuance system T1 (step S64). Next, the mining described above is performed in the blockchain network 7, and the NFT transmit transaction is recorded in the blockchain (step S65). When the recording is completed, the blockchain network 7 performs the ownership transition of the card tokens that is subject to be transmitted in the operator wallet DW and the user wallets UWa, UWb (step 66). Accordingly, the card token held in the reprint list SC3 of the operator wallet DW is moved to a wallet of the owner of the card token decided in the step S54 in FIG. 13 (step 67). The card token reprinted in this way will be circulated in the market to be subjected to sale, exchange, and trading between users.

As described above, according to the card ownership management system 1 of the present embodiment, the non-fungible token which can give the user the ownership is used as the trading card, and the non-fungible token is also used for exchange, and therefore, the trading card can be exchanged without sending in the mail. In addition, since the non-fungible token (trading card) does not deteriorate, the non-fungible token for exchange or the non-fungible token for sale that is obtained through exchange can also be resold or redistributed. Therefore, issuing the trading card for exchange becomes possible.

Further, the card ownership management system 1 of the present embodiment also allows purchasing of the card token by the user, trading of the card token between the users, and reprinting of the card token according to the transaction status.

A preferable embodiment of the present invention was described above, but the present invention is not limited in any way to the embodiment noted above, and various forms are, of course, possible without departing from the scope of the present invention.

### DESCRIPTION OF REFERENCE NUMERALS

1 Card ownership management system
2 Network
3 Operating terminal
4, 4a, 4b User terminal
5 NFT management server
6 Application server
7 Blockchain network
10 User information
11 Return button
12 Animation image
13-17, 55, 56 Operation button
20 Token set
21 Price
22, 24, 50 Purchase button
23 Combo badge
25 Cancel button
26, 54 Purchase completion window
30 Card token for exchange
31,40 Card token
32, 34 Exchange button
33 Select button
35 Exchange completion window
41 For-sale button
51 Purchase confirmation window
52 Yes button
53 No button
100 Computer
101 CPU
102 Storage device
103 Input device
104 Output device
105 Communication device
A1 Market system
D1 Token management database
DW Operator wallet
E1 Event monitoring system
M1 Metadata management system
OC1 Current log analysis system
SC1 Sales list
SC2 Exchange list
SC3 Reprint list
T1 NFT issuance system
UW, UWa, UWb User Wallet

1. A card ownership management system wherein,
receiving from a first user terminal an exchange instruction including information specifying a non-fungible token for exchange held in an operator wallet that holds a plurality of non-fungible tokens and information specifying one or more non-fungible tokens held in a first user wallet that holds one or more non-fungible tokens owned by a user of the first user terminal;
moving the non-fungible token for exchange specified based on the exchange instruction to the first user wallet from the operator wallet; and
moving one or more non-fungible tokens specified based on the exchange instruction to the operator wallet from the first user wallet.

2. The card ownership management system according to claim 1, wherein
the non-fungible token for exchange includes information indicating one or more non-fungible tokens required for exchange;
determines whether one or more non-fungible tokens specified by the exchange instruction match the one or more non-fungible tokens indicated by the non-fungible tokens for exchange; and
when determined they match, moves the non-fungible token for exchange specified based on the exchange instruction to the first user wallet from the operator wallet and moves one or more non-fungible tokens specified based on the exchange instruction to the operator wallet from the first user wallet.

3. The card ownership management system according to claim 1, wherein
a first purchase instruction specifying the non-fungible token for sale held in the operator wallet is received from the first user terminal; and
the non-fungible token for sale specified based on the first purchase instruction is moved to the first user wallet from the operator wallet.

4. The card ownership management system according to claim 3, wherein the non-fungible token for sale is one or more non-fungible tokens specified based on the exchange instruction.

5. The card ownership management system according to claim 4, wherein
the first purchase instruction includes information about a payment method;
determines whether a required amount to purchase the non-fungible token for sale can be paid by the payment method indicated in the first purchase instruction; and
when determined the payment can be made, moves the non-fungible token for sale specified based on the first purchase instruction to the first user wallet from the operator wallet.

6. The card ownership management system according to claim 5, wherein the required amount to purchase the non-fungible token for sale includes a price of the non-fungible token for sale and a fee required for recording a smart contract transaction indicating the purchase of the non-fungible token for sale in the blockchain network.

7. The card ownership management system according to claim 1, wherein
receiving from the first user terminal a listing instruction specifying the non-fungible token held in the first user wallet;
adding the non-fungible token specified based on the listing instruction to a for-sale list and displaying the for-sale list on a second user terminal;
receiving from the second user terminal a second purchase instruction specifying the non-fungible token included in the for-sale list; and
moving the non-fungible token specified based on the second purchase instruction from the first user wallet to the second user wallet holding one or more non-fungible tokens owned by a user of the second user terminal.

8. The card ownership management system according to claim 7, wherein
the second purchase instruction includes information about the payment method;
determines whether the required amount to purchase the non-fungible token specified based on the second purchase instruction can be paid by the payment method indicated in the second purchase instruction; and
when determined the payment can be made, moves the non-fungible token specified based on the second purchase instruction to the second user wallet from the first user wallet.

9. The card ownership management system according to claim 8, wherein
the listing instruction includes information indicating a for-sale price; and
the required amount to purchase the non-fungible token specified based on the second purchase instruction includes the for-sale price included in the listing instruction and the fee required for recording a smart contract transaction indicating of trading the non-fungible token specified based on the second purchase instruction between the users in the blockchain network.

10. The card ownership management system according to claim 1, wherein
receiving an issuance instruction specifying the non-fungible token; and
adding the non-fungible token specified based on the issuance instruction to the operator wallet.

11. The card ownership management system according to claim 1, wherein
determining whether conditions for reprinting the non-fungible token have been met based on a history data of an event on the non-fungible token; and
when determined that the conditions for reprinting have been met for the first non-fungible token, the first non-fungible token is added to at least one of the operator wallet and the first user wallet.

12. The card ownership management system according to claim 11, wherein when a transaction price of the first non-fungible token indicated in the history data exceeds a predetermined threshold, determines that the conditions for reprinting the first non-fungible token have been met.

13. The card ownership management system according to claim 11, wherein
determining whether the number of issued first non-fungible token reaches the number of tokens to be issued; and
when determined that the conditions for reprinting the first non-fungible token have been met and that the number of issued first non-fungible token has not reached the number of tokens to be issued, the first non-fungible token is added to at least one of the operator wallet and the first user wallet.

14. A card ownership management method executed by a computer, the card ownership management method comprising:
receiving, by the computer, from a first user terminal an exchange instruction including information specifying a non-fungible token for exchange held in an operator wallet that holds a plurality of non-fungible tokens and information specifying one or more non-fungible tokens held in a first user wallet that holds one or more non-fungible tokens owned by a user of a first user terminal;
moving by the computer, the non-fungible token for exchange specified based on the exchange instruction to the first user wallet from the operator wallet; and
moving one or more non-fungible tokens specified based on the exchange instruction to the operator wallet from the first user wallet.

15. A program wherein a computer executes:
receiving from a first user terminal an exchange instruction including information specifying a non-fungible token for exchange held in an operator wallet that holds a plurality of non-fungible tokens and information specifying one or more non-fungible tokens held in a first user wallet that holds one or more non-fungible tokens owned by a user of the first user terminal;
moving the non-fungible token for exchange specified based on the exchange instruction to the first user wallet from the operator wallet; and
moving one or more non-fungible tokens specified based on the exchange instruction to the operator wallet from the first user wallet.
